(19) United States
(12) Patent Application Publication
(10) Pub. No.: US 2026/0104788 A1
(43) Pub. Date: Apr. 16, 2026

(54) MESSAGE SENDING METHOD AND APPARATUS, AND ELECTRONIC DEVICE AND STORAGE MEDIUM

(71) Applicant: Beijing Zitiao Network Technology Co., Ltd., Haidian District, Beijing (CN)

(72) Inventors: Zhifeng LIN, Beijing (CN); Zeming QIU, Beijing (CN); Haochun LIAO, Beijing (CN); Weirun CHEN, Beijing (CN); Qinghong CHEN, Beijing (CN)

(21) Appl. No.: 18/998,332

(22) PCT Filed: Sep. 15, 2023
(86) PCT No.: PCT/CN2023/119162

§ 371 Date: Jan. 24, 2025

(30) Foreign Application Priority Data
Oct. 14, 2022 (CN) 202211263438.X

(51) Int. Cl. G06F 3/04847; G06F 16/903; G06F 40/166; G06T 11/10; H04L 51/02; H04L 51/04

(52) U.S. Cl. CPC G06F 3/04847; G06F 16/90335; G06F 40/166; G06T 11/10; H04L 51/02; H04L 51/04; G06T 2200/24

(57) ABSTRACT

A method for sending a message includes: in response to receiving, on an online document interface, a trigger operation for creating a message sending procedure, displaying a message configuration interface, wherein the message sending procedure is used for sending a message to an instant messaging application, and the message configuration interface comprises a message field comprising at least one of a message title, a message content and a message control; obtaining an editing operation for the message field, and matching a corresponding editing result based on the editing operation, and displaying the editing result on the message configuration interface; and in response to a confirm operation for storage and activation, storing and activating the message sending procedure. The technical solution of the present disclosure can satisfy the need for sending diversified messages to an instant message application.

### CROSS-REFERENCE TO RELATED APPLICATION(S)

The present disclosure claims the priority from the CN patent application No. 202211263438.X entitled “MESSAGE SENDING METHOD AND APPARATUS, AND ELECTRONIC DEVICE AND STORAGE MEDIUM” filed with the China National Intellectual Property Administration (CNIPA) on Oct. 14, 2022, the content of which is hereby incorporated by reference in its entirety.

### FIELD

The present disclosure relates to the technical field of computers, in particular, to a message sending method, apparatus, an electronic device and a storage medium.

### BACKGROUND

Nowadays, due to the merits of supporting multi-person collaboration and sharing, completing data collection using forms, saving and modifying logs instantly, allowing management by permissions, flexibility and high efficiency, and the like, online documents (e.g. online forms) have a wide application range covering multiple application scenarios such as sales management, e-commerce management, teaching management, chain store management, and the like. In some application scenarios (e.g. sales management), users need to send data information (e.g. sales reports) through instant messaging applications.

### SUMMARY

In view of the above, the objective of the present disclosure is to provide a method and an apparatus for sending a message, an electronic device and a storage medium.

In order to accomplish the above objective, in the first aspect, the present disclosure provides a method for sending a message, which can be applied to online documents, comprising:

in response to receiving, on an online document interface, a trigger operation for creating a message sending procedure, displaying a message configuration interface, wherein the message sending procedure is used for sending a message to an instant messaging application, and the message configuration interface comprises a message field comprising at least one of a message title, a message content and a message control;

obtaining an editing operation for the message field, matching a corresponding editing result based on the editing operation, and displaying the editing result on the message configuration interface; and

in response to a confirm operation for storage and activation, storing and activating the message sending procedure.

In a second aspect, the present disclosure provides an apparatus for sending a message, comprising:

a trigger module configured to: in response to receiving, on an online document interface, a trigger operation for creating a message sending procedure, display a message configuration interface, wherein the message sending procedure is used for sensing a message to an instant messaging application, and the message configuration interface comprises a message field comprising at least one of a message title, a message content and a message control;

an editing module configured to obtain an editing operation for the message field, match a corresponding editing result based on the editing operation, and display the editing result on the message configuration interface; and

an activation module configured to: in response to a confirm operation for storage and activation, store and activate the message sending procedure.

In a third aspect, the present disclosure provides an electronic device, comprising: a memory; a processor; and one or more programs, wherein the one or more programs are stored in the memory and executed by the one or more processors, and the one or more programs include instructions for executing the method according to the first aspect.

In a fourth aspect, the present disclosure provides a non-transitory computer readable storage medium having computer instructions stored thereon, wherein the computer instructions, when executed, cause a computer to implement the method according to the first aspect.

As could be seen from the above, according to the method and the apparatus for sending a message, the electronic device, the storage medium and the program product provided by the present disclosure, a message configuration interface is displayed when creating a message sending procedure, such that users can edit message fields included on the message configuration interface to complete a configuration for automatically sending messages, which is helpful to meet the needs for sending diversified messages.

### BRIEF DESCRIPTION OF THE DRAWINGS

In order to make clearer the technical solution according to the present disclosure or the related technology, brief introduction of the drawings required in the respective embodiments or the related technology will be provided below. It would be appreciated that the drawings described below only illustrate some embodiments of the present disclosure, on the basis of which the ordinary skill in the art could derive other related drawings, without doing creative work.

FIG. 1 illustrates a schematic diagram of an online document provided by embodiments of the present disclosure;

FIG. 2 illustrates a schematic diagram of an instant messaging application system provided by embodiments of the present disclosure;

FIG. 3 illustrates a schematic diagram of interaction between an online document and an instant messaging application provided by embodiments of the present disclosure;

FIG. 4A illustrates a schematic diagram of an example page according to embodiments of the present disclosure;

FIG. 4B illustrates a schematic diagram of an example page according to embodiments of the present disclosure;

FIG. 5A illustrates a schematic diagram of two example pages according to embodiments of the present disclosure;

FIG. 5B illustrates a schematic diagram of an example page according to embodiments of the present disclosure;

FIG. 5C illustrates a schematic diagram of an example page according to embodiments of the present disclosure;

FIG. 5D illustrates a schematic diagram of an example page according to embodiments of the present disclosure;

FIG. 5E illustrates a schematic diagram of an example page according to embodiments of the present disclosure;

FIG. 5F illustrates a schematic diagram of an example page according to embodiments of the present disclosure;

FIG. 5G illustrates a schematic diagram of an example page according to embodiments of the present disclosure;

FIG. 5H illustrates a schematic diagram of an example page according to embodiments of the present disclosure;

FIG. 6A illustrates a schematic diagram of an example page according to embodiments of the present disclosure;

FIG. 6B illustrates a schematic diagram of an example page according to embodiments of the present disclosure;

FIG. 6C illustrates a schematic diagram of an example page according to embodiments of the present disclosure;

FIG. 6D illustrates a schematic diagram of an example page according to embodiments of the present disclosure;

FIG. 6E illustrates a schematic diagram of an example page according to embodiments of the present disclosure;

FIG. 7 illustrates a flowchart of an example method provided by embodiments of the present disclosure;

FIG. 8 illustrates a flowchart of a further example method provided by embodiments of the present disclosure;

FIG. 9 illustrates a schematic diagram of an example apparatus provided by embodiments of the present disclosure; and

FIG. 10 illustrates a schematic diagram of a hardware structure of an example computer device provided by embodiments of the present disclosure.

### DETAILED DESCRIPTION OF EMBODIMENTS

In order to make the objective, the technical solution and the advantages of the present disclosure more apparent, the present disclosure will be further detailed in conjunction with specific embodiments and with reference to the accompanying drawings.

Unless defined otherwise, technical and scientific terms used herein have the same meaning as is commonly understood by one of ordinary skill in the art to which this disclosure belongs. The terms “first,” “second” and the like, as used herein, do not denote any order, quantity or importance, but rather are used to distinguish one element from another. The use of “including” or “comprising” and variations thereof herein means that an element or object before the word encompasses elements or objects listed thereafter and equivalents, but do not exclude other elements or objects.

According to the prior art, for a user simultaneously using an online document and an instant messaging application, when he/she is mentioned in an edited content in an online document or by other user(s), a notification message from the online document can be received in the instant messaging application, which generally corresponds to a link address, so as to enable the user to jump to the corresponding online document via the link address.

As stated above in the technical background, in an application scenario, for example, sales management, e-commerce management, teaching management, chain store management, or the like, users have the need for sending data information (e.g. sales reports) in the instant messaging application. Obviously, according to the prior art, sending a message from the online document to the instant messaging application can be implemented for an individual user, but not for a group, and the message contents are not sufficiently diversified to satisfy new user needs in various application scenarios.

In view of the above, embodiments of the present of the present disclosure provide a method for sending a message. When creating a message sending procedure, a message configuration interface is displayed, such that a user can edit message fields included on the message configuration interface to complete a configuration for automatically sending messages, which is helpful to meet the needs for sending diversified messages.

FIG. 1 illustrates a schematic diagram of an application system of the method for sending a message provided by embodiments of the present disclosure. The application system 100 may be an online document, for example, a google sheet, Graphite documentation, an iFlytek document and the like.

The system 100 may include a first terminal 102, a first server 104 and a second terminal 106. Wherein, the first terminal 102 and the second terminal 106 are only used for differentiating different electronic devices, not limiting a number of electronic devices in an application scenario. In practice, there may be a plurality of electronic devices, including, but not limited to: desktop computers, mobile phones, mobile computers, tablet computers, media players, wearable smart devices, Personal Digital Assistants (PDAs), or other electronic devices capable of performing the above function. The first terminal 102 and the second terminal 106 can run an application, and can provide users with corresponding services via the application, for example, creating a document, modifying a document and the like. By way of example, for an online form, building an automated process is typically performed on a PC, while adding data to a certain online form can be performed on a mobile device.

The first server 104 may be a single server or a plurality of servers. In the case of a plurality of servers, the servers may have a distributed architecture and form a server cluster.

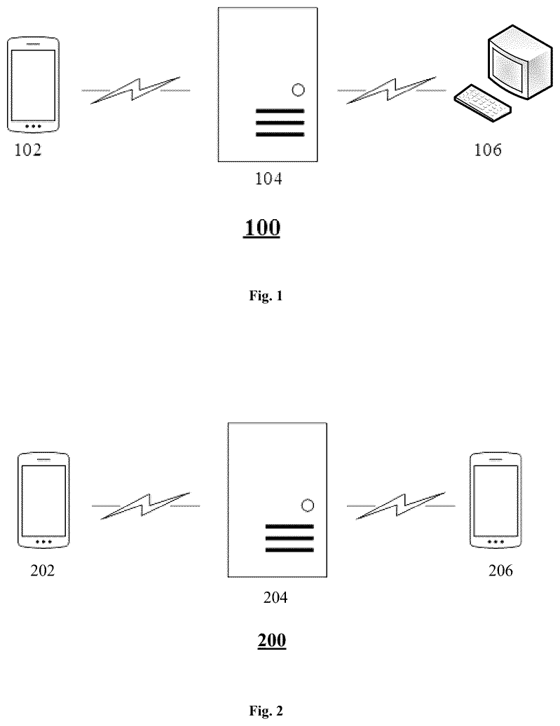

FIG. 2 illustrates a schematic diagram of an Instant Messaging (IM) application system 200 provided by embodiments of the present disclosure. The system 200 may include a first terminal 202, a second server 204 and a second terminal 206. Wherein, the first terminal 202 and the second terminal 206 are only used for differentiating different electronic devices, not limiting a number of electronic devices in an application scenario. In practice, there may be a plurality of electronic devices, including, but not limited to: desktop computers, mobile phones, mobile computers, tablet computers, media players, wearable smart devices, Personal Digital Assistants (PDAs), or other electronic devices capable of performing the above function. The first terminal 202 and the second terminal 206 can run an application, and can provide users with corresponding services via the application, for example, a chat service and the like. Similarly, the first server 204 may be a single server or a plurality of servers. In the case of a plurality of servers, the servers may have a distributed architecture and form a server cluster.

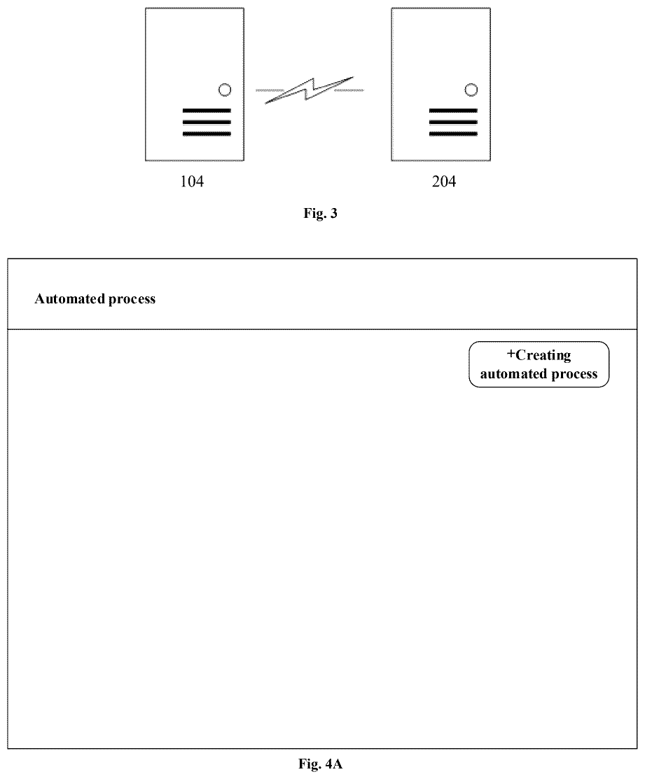

FIG. 3 illustrates a schematic diagram of interaction between an online document and an instant messaging application. The first server 102 can receive an interaction request filed by a first user in the online document and push the request to the second server 204. Upon receiving the interaction request, the second server 204 can send the interaction request to a second user specified by the first user. In some embodiments, if the second server 204 cannot send the interaction request to the second user, it can remind the first user on the instant messaging terminal corresponding to the first user, or feed a corresponding result back to the first server 104. For the result, the first server 104 can choose to save it as a run log.

It is worth noting that the first user simultaneously has accounts for the online document and the instant messaging application, and according to a preset condition, the online document and the instant messaging application can bind the two accounts of the first user, so that the first user can utilize the social network relationship in the instant messaging application.

By way of example, the online form and the instant messaging application belong to the same application platform, and the same user account is applied for the online form and the instant messaging application.

It would be appreciated that the above description on the online document and the instant messaging application is provided only for understanding the spirits and principle of the present disclosure, and the implementations of the present disclosure is not limited in the aspect. Rather, the implementations of the present disclosure can be applied to any suitable scenario.

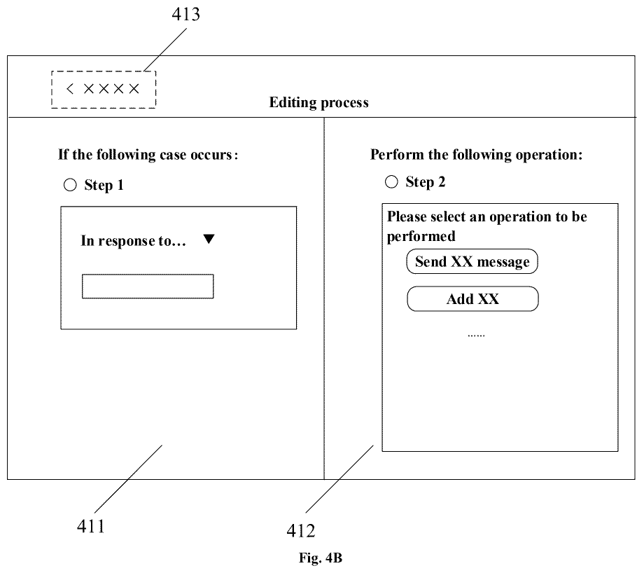

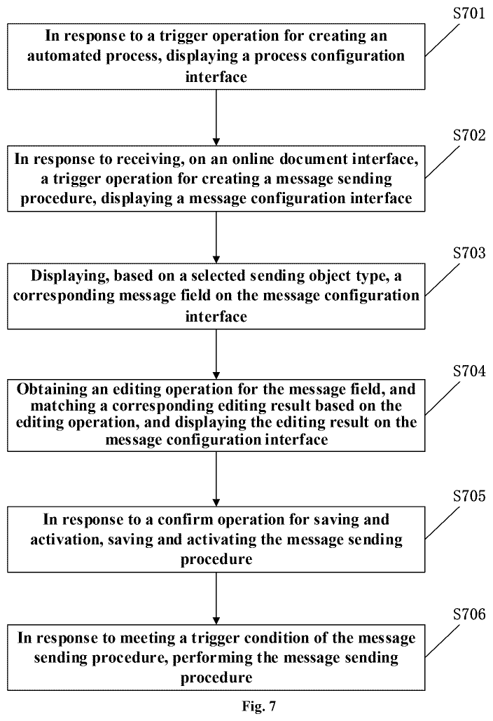

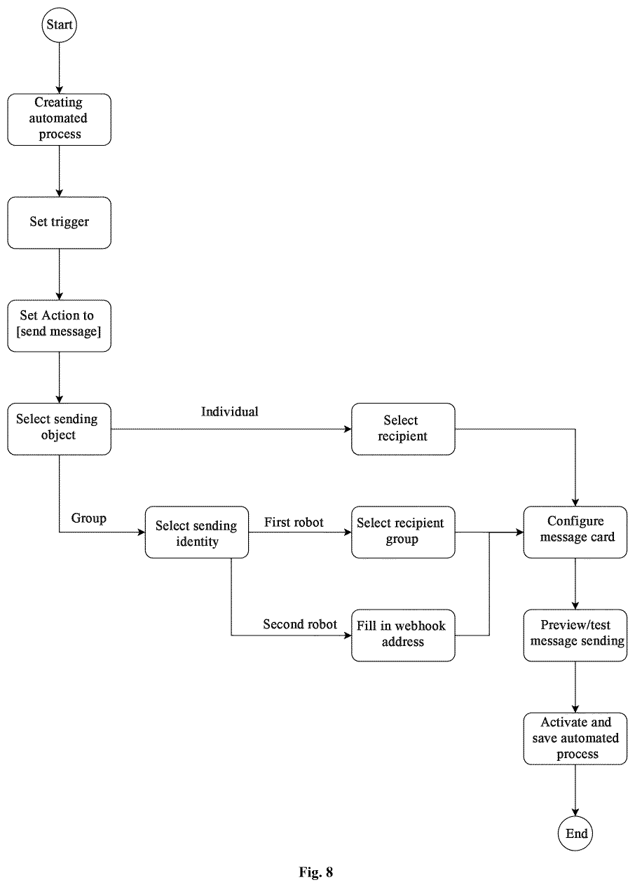

Reference below will be made to FIGS. 4A-8 to describe in detail the method for sending a message provided by the present disclosure, where FIGS. 7 and 8 illustrate a flowchart of sending a message, respectively. The method specifically includes:

Step S701: in response to a trigger operation for creating an automated process, displaying a process configuration interface, wherein the process configuration interface comprises a trigger condition interface 411 and a to-be-selected process interface 412, and wherein the to-be-selected process interface 412 comprises a message sending procedure.

In some embodiments, FIG. 4A shows entering an interface for creating an automated process, where a function key for creating the automated process is displayed. A user can trigger an operation of creating the automated process by clicking the function key.

In some embodiments, the process configuration interface is shown in FIG. 4B. The left side of FIG. 4B shows a trigger condition interface 411, and the right side thereof shows a to-be-selected process interface 412.

The trigger condition may be adding a new log, changing a log content, triggering a timer, or the like, which is not limited specifically herein. The trigger condition can be selected by dropping down the menu as shown therein. In addition, it can be set to simultaneously meet other conditions, i.e., it can be set to meet a plurality of conditions to trigger the automated process, which will not be detailed herein.

In addition to sending a message, the to-be-selected processes displayed on the to-be-selected process interface may further include adding a log, modifying a log, looking for a log, and the like, which is not limited specifically herein.

In some embodiments, the process configuration interface further displays a title bar 413 which displays a name of an automated process created subsequently by the user, so as to distinguish it from other automated processes.

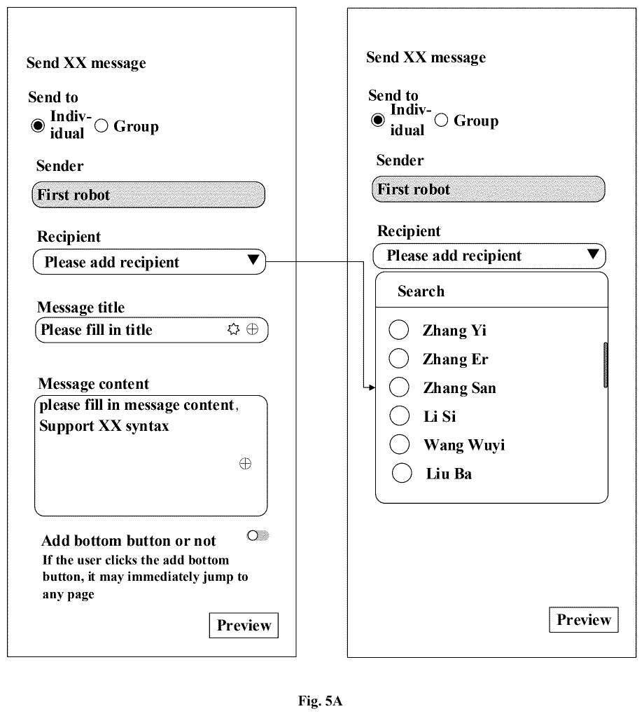

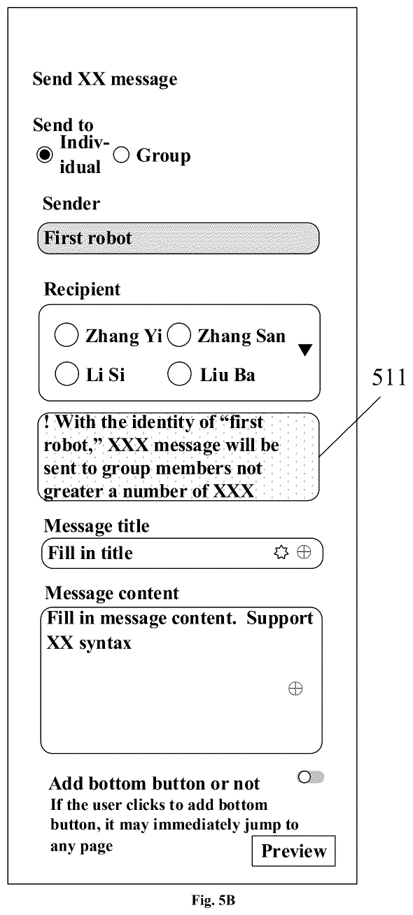

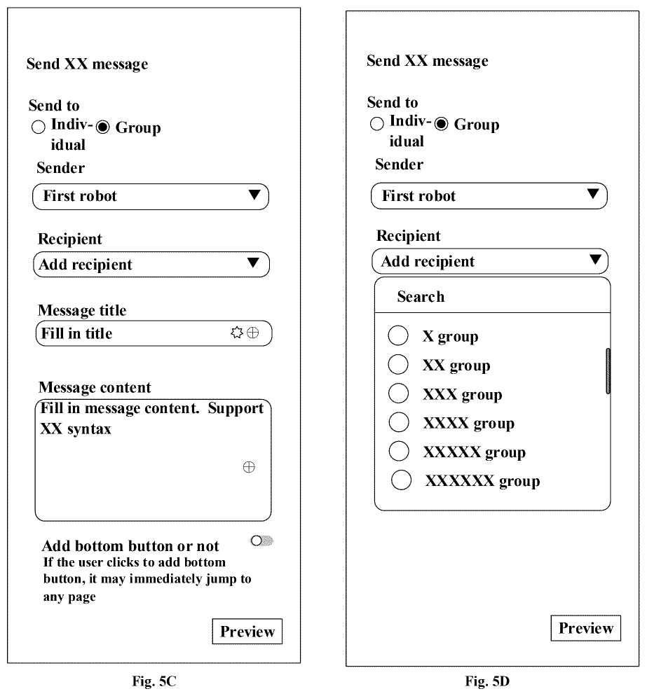

Step S702: in response to receiving, on the online document interface, a trigger operation for creating the message sending procedure, displaying a message configuration interface (FIGS. 5A and 5C); wherein the message sending procedure is used for sending a message in the instant messaging application; and wherein the message configuration interface comprises at least one sending object type.

By way of example, FIGS. 5A and 5C show two types of sending objects, namely an individual and a group.

As used herein, sending the message to an individual may include sending the message to a person in the contact list of the instant messaging application, or sending the message to each person in a group; and sending the message to a group indicates sending the message to a group.

Step S703: displaying, based on a selected sending object type, a corresponding message field on the message configuration interface. As used herein, the message field includes at least one of a message title, a message content and a message control.

By way of example, referring to FIG. 5A, in response to that the sending object type is an individual, the message field includes a sender, a recipient, a message title, a message content and a message control.

By way of example, referring to FIG. 5c, in response to that the sending object type is a group, the message field comprises a sender, a recipient group, a message title, a message content and a message control.

As shown in FIG. 5F, an option of the sender comprises at least one of a first robot and a second robot; the first robot is preset in the instant messaging application and is capable of sending a message to each user of the instant messaging application; and the second robot is preset in a group of the instant messaging application and is capable of sending a message to the corresponding group.

In some embodiments, in response to that the sending object type is an individual, the option of the sender is configured as the first robot. Herein, if the sending object is an individual, it is default that the first robot is a sender, and the option of the sender is grayed out correspondingly, to indicate that the first robot is a default sender, as shown in FIG. 5A.

In some embodiments, in response to that the sending object type is a group, the option of the sender is configured as the first robot and the second robot. It would be appreciated by those skilled in the art that the user may choose the first robot or the second robot as the sender.

Step S704: obtaining an editing operation for the message field, matching a corresponding editing result based on the editing operation, and displaying the editing result on the message configuration interface.

Specifically, as shown in FIG. 5G, in response to determining that the second robot is a sender, a message address of the robot and at least one address bar are displayed on the message configuration interface, where the address bar is used for inputting a message address of the second robot. Since the second robot is preset in the group of the instant messaging application, the message address of the second robot is typically the webhook address.

Herein, if the second robot is a robot created by the user in the group of the instant messaging application, the corresponding webhook address can be directly copied and pasted in the address bar; if the second robot has not been created in the group of the instant messaging application, the user needs to add a custom robot to the group of the instant messaging application to obtain a corresponding webhook address.

Optionally, the message configuration interface further includes a first prompt icon 522. When the user clicks the first prompt icon 522, the following prompt text can be displayed: Please add a custom robot or select a robot you have created in Group Settings→Group Robot, then copy the webhook address of the robot and paste it here. In this way, an instruction will be provided for the user to edit the message field, which can reduce the difficulty in user operation while improving the efficiency of the user creating an automated process.

In some embodiments, referring to FIG. 5H, the message configuration interface may further include an address adding item 524; in response to a trigger operation for the address adding item, an address bar is added. Herein, the number of address bars corresponds to a number of second robots, i.e., a number of recipient groups.

Optionally, the upper limit of recipient groups for a single node is 5. By way of example, for a trigger condition, the upper limit of recipient groups is 5.

Optionally, the upper limit of recipient groups for a single process is 5. By way of example, if an automated message sending procedure includes three trigger conditions (i.e., messages can be sent separately if the three conditions are met), the total upper limit of the recipient groups for the three trigger conditions is 10.

In some embodiments, as shown in FIG. 5H, in response to an input operation for the message address of the second robot, the message address is verified according to a message address rule; and in response to that the message address is not correct, an error is reported based on a preset text. Wherein, an error area 523 is located below the error address.

By way of example, the webhook address of the second robot should be in line with: https://open.xxxxx.cn/open-apis/bot/v2/hook/[hook_id]; if the input address does not conform to the rule, an error is reported as follows: “The webhook address is not correct. Please check.” By setting the first robot and the second robot, the sender type is added, such that messages can be sent to an individual or a group, which broadens the message sending range.

In some embodiments, as shown in FIGS. 5A and 5D, the recipient/recipient group is configured with a search bar.

In response to an input operation for a search content, a request is sent to the instant messaging application to search for individuals and groups in contacts; optionally, the first server 104 sends a request to the second server 204.

A search result fed back by the instant messaging application can be obtained and displayed; optionally, the second server 204 sends feedback to the first server 104, and the first server 104 sends feedback to the user terminal.

In response to a selection operation for an individual or a group in the search result, a corresponding individual and/or group is added as the recipient and/or the recipient group.

In the case of a recipient, since the message is sent to each group member, the search result shows the external contacts in the contact list, not external groups.

In the case of the recipient group, the search result shows the internal group and the external group.

By way of example, in response to that the sending object type is an individual, the recipient is configured to support an individual, an internal group, or a combination of an individual and an internal group. It would be appreciated that, for an internal group, the recipient is each member in the internal group, which does not mean sending a group message.

Since the message is sent to each member in the group, in order to avoid information interference, in some embodiments, as shown in FIG. 5B, in response to that the recipient includes a group, the message configuration interface further includes a second prompt icon 511 located in an area below the recipient, to enable a user to create an anticipation of sending messages to each group member. The prompt text of the second prompt icon may be “With the identity of ”first robot,“ notifications will be sent to each group member. Please use the notifying function wisely, avoiding information interruption. Currently, it is only supported to send messages to 200 group members or less.”

Further, the number of the group members is limited. If the selected group has more members than the predetermined number, the message sending will fail, and the failure will be automatically fed back to the user.

By way of example, in response to that the sending object type is a group, the recipient group is configured to support adding an internal group and an external group. The number of groups is limited likewise as stated above, details of which are omitted herein for brevity. Optionally, the number of members in a group is not limited.

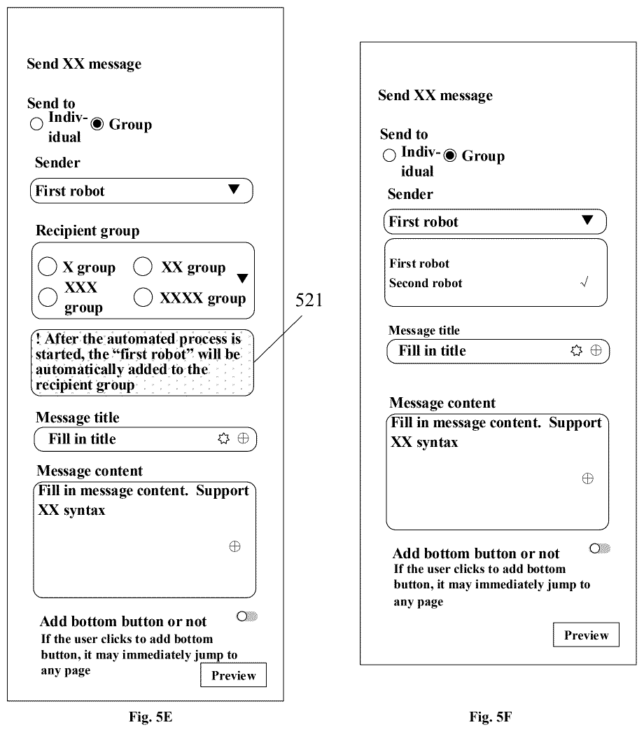

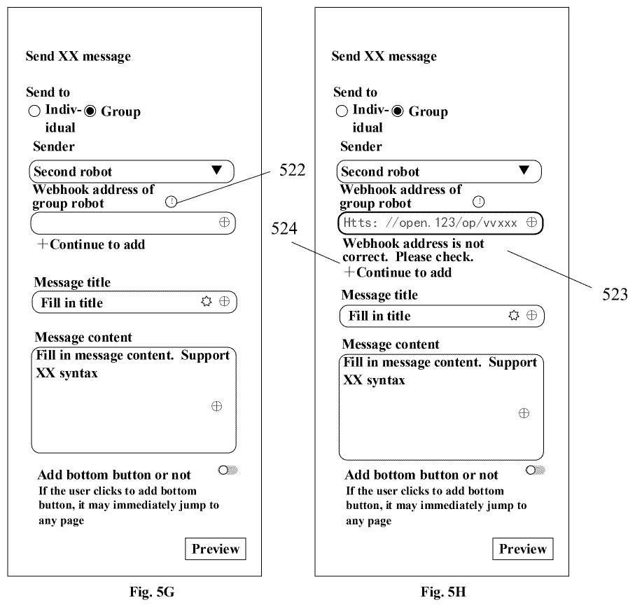

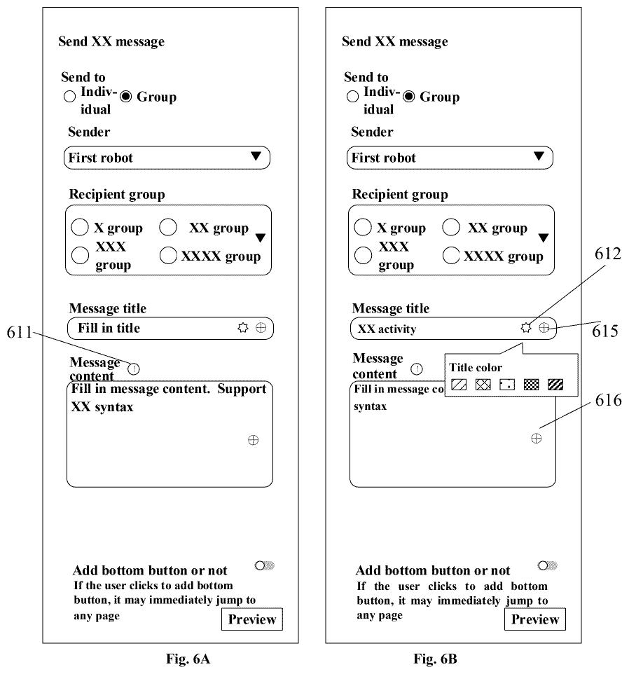

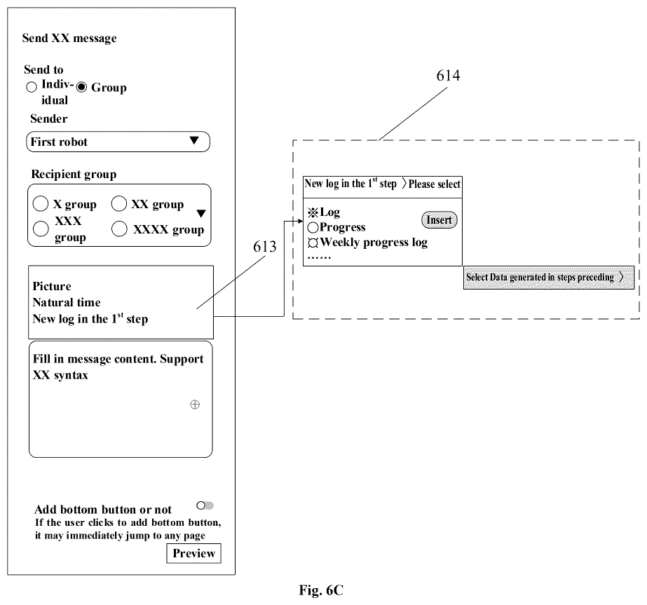

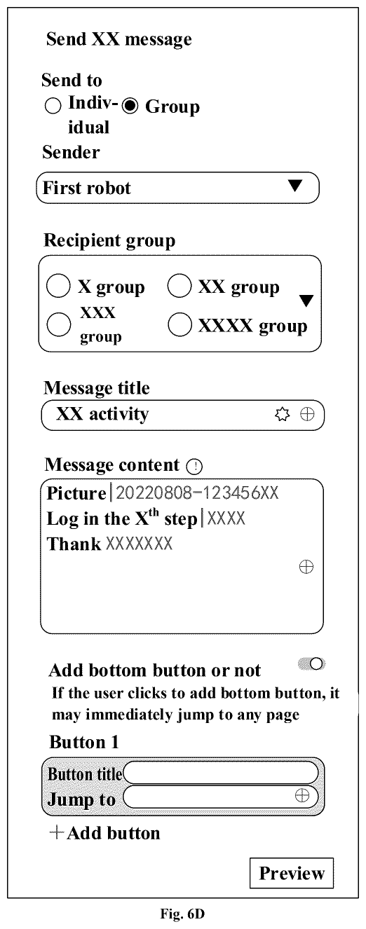

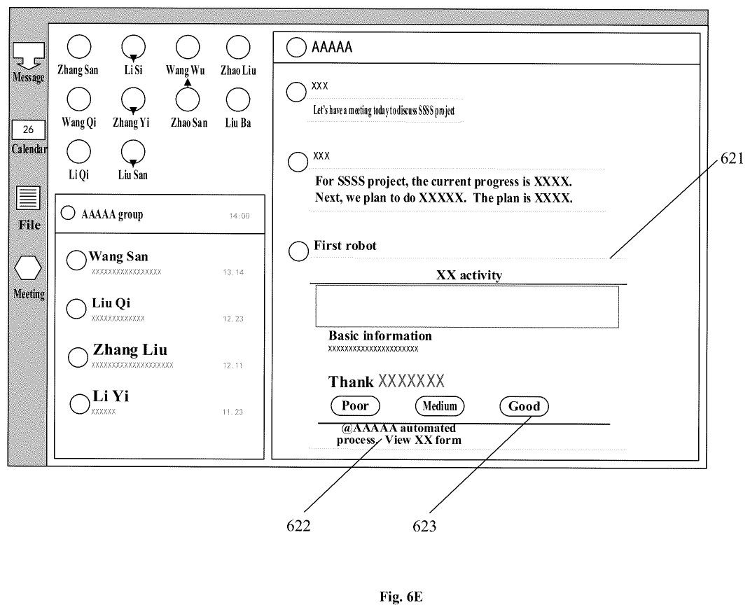

FIGS. 6A-6C illustrate schematic diagrams of a partial page when editing the message title and the message content.

As shown in FIG. 6B, the message title is configured with a color palette 612; the method includes:

in response to a trigger operation for the color palette, displaying at least two colors including at least two of light blue, turquoise, crimson, violet, purple, indigo, and gray; and

in response to a selection operation for any of the at least two colors, determining a background color of the message title, and a font color matching the background color.

It would be appreciated that default background color of the message title is transparent.

In response to editing the background color of the message title, the message title is configured to be displayed with the selected background color and the matching font color in a message card of the instant messaging application. In this way, it is advantageous for making the message title more distinctive and more attractive.

In some embodiments, as shown in FIG. 6A, the message content is configured to support a preset text markup syntax, and the preset text markup syntax is used for adjusting a format of a text. Optionally, the third prompt icon 611 shows a part of the preset text markup syntax.

By way of example, the preset text markup syntax is MarkDown syntax. The MarkDown syntax enables bold, italic, text links, @person, split lines and the like. The text of the third prompt icon 611 may be: “MarkDown syntax, bolding: **text**, italicizing: _text_, text link: [text].”

In response to editing the message content using the preset text markup syntax, the message content is configured to be displayed in a message box of the instant messaging application in an effect corresponding to the preset text markup syntax. In this way, it is advantageous for making the message content more distinctive, more diversified and more attractive, thus meeting the user needs for displaying the message contents in a more diversified effect.

By way of example, the preset text markup syntax is MarkDown syntax, and the edited part “**text**” in the message content corresponds to “text” in the message card and is displayed in bold.

In some embodiments, as shown in FIG. 6B, the message title is configured with a first reference mark 615; the message content is configured with a second reference mark 616; obtaining the editing operation for the message field, matching the corresponding editing result based on the editing operation, and displaying the editing result on the message configuration interface, specifically include:

in response to a trigger operation for the first reference mark 615 or the second reference mark 616, displaying at least one item to be selected 613 (as shown in FIG. 6C); and

in response to a selection operation for the item to be selected 613, matching and displaying a corresponding effect interface 614 based on the selected item to be selected (as shown in FIG. 6C), wherein the effect interface 614 comprises displaying, in the message content, the selected item (not shown in the figure) or a subsequent option available to a user (as shown in FIG. 6C)

By way of example, the item to be selected is natural time, and the corresponding effect interface displays the natural time field in the message content field.

The item to be selected is a first picture, and the corresponding effect interface includes a subsequent option of a target picture available to the user. It is worth noting that the subsequent option may have multiple levels, and the effect interface can display stepwise the subsequent option to guarantee that the user can select the target picture. For example, if the picture address is in the first subfolder of the first folder in the local disk D, the subsequent option include three levels, and the effect interface displays the disk D, the first folder and the first subfolder, respectively.

In an online form, through the effect interface 614, the user can select adding a new log included in the trigger condition, and then select a certain field in the log.

In some embodiments, the item to be selected includes a first picture; the subsequent option is used for specifying a target picture corresponding to the first picture, and the method further includes:

in response to a determining operation for the target picture, sending the target picture to the first robot to obtain a picture address of the target picture; and displaying the target picture in a preset format in the message content of the message configuration interface.

Optionally, the address of the target picture is image-key; the instant messaging application can search for the target picture based on the picture address, and display the same in the message content on the chat interface.

Optionally, the first picture of the message content is displayed in a predetermined format, for example, “picture|$picture name $.”Optionally, the first picture is selected from the local pictures.

In some embodiments, the subsequent option includes an information category of the online document, such that an information content corresponding to the information category is capable of being embedded into the message title or the message content.

Further, the method includes:

in response to that the information category corresponds to a second picture, sending the target picture corresponding to the second picture to the first robot, so as to obtain a picture address of the target picture; and presenting a field name corresponding to the target picture in the message content of the message configuration interface (i.e., the method for sending the message supports selecting a picture in the online document as the message content and sending the same to the recipient/recipient group of the instant messaging application; it would be appreciated that the attachment corresponding to the information category is skipped if not in the picture format);

in response to that the information category corresponds to a person, converting the message content of the message configuration interface to point to the person (herein, pointing to a person may be expressed in the form of @person); and

in response to that the information category corresponds to a text, displaying a category name corresponding to the text in the message content of the message configuration interface.

It is worth noting that the method for sending a message according to the present disclosure has a trigger condition, for example, new input information, and the details of the information therefore cannot be determined in the process of editing the message content. In the case, a corresponding type name, and a field name corresponding to the second picture are displayed in the part of the message content.

The first picture and the second picture may be in the format of JEPG(.jpg), PNG(.pgn), GIF(.gif), TIFF(.tif), PSD(.psd), or RAW(.dng/.cr2/.nef), which is not limited specifically herein.

Optionally, the first picture and the second picture each have a size no greater than 10 MB. Optionally, the maximum number of pictures displayed per message is 5.

In some embodiments, in response to the operation of selecting the information category, an information content corresponding to the information category is configured to be displayed in a message card of the instant messaging application, so as to embed a specific message content. For example, if the message category is a picture, a target picture is displayed in the message card; for another example, if the message category is sales data, specific sales values are displayed in the message card.

In some embodiments, as shown in FIGS. 6D and 6E, the message control includes an option for adding a button or not, wherein a button 623 is used for setting a link in the message; the method further includes:

in response to a trigger operation for adding a button or not, the message configuration interface displays a button title input box and a jump to input box. It would be appreciated that the button title input box is used for inputting a button title, and the jump to input box is used for inputting a link address.

Further, the message configuration interface further includes a button adding option; in response to a trigger operation for the button adding option, the button title input box and a jump to input box are added on the message configuration interface.

For example, the following are displayed: a button 2 and a button title input box and a jump to input box corresponding thereto; or a button 3 and a button title input box and a jump to input box corresponding thereto, which are not shown in the figure.

Optionally, the maximum number of buttons is 3; and the maximum length of the title is 15 Chinese characters.

In a case of a plurality of the buttons, the buttons are configured to be displayed in the same line in the message card in the instant messaging application. With the display in the same line, a more organized visual effect can be achieved, and it enables a user to view all buttons, thus improving the visual exposure of button and avoiding missing any of them.

In some embodiments, referring to FIG. 6E, the message title, the message content and the message control are configured to form a message card 621 in the instant messaging application.

Specifically, a position order of the message title, the message content and the message control in the message box is determined based on a position order of the message title, the message content and the message control on the message configuration interface. Such arrangement is helpful for the user to predict the visual display effect of the message card and provides convenience for the user to perform a predictive editing operation on the message field, thus improving the editing accuracy and enhancing the display effect for the message field.

By way of example, the message control is located below the message content, i.e., the message control is located at a bottom of the message card.

In response to that the message content includes a text and a picture, the position order of the text and the picture in the message card is determined based on the position order of the text and the picture, and the text and the picture are displayed in different lines. The picture may be from a local picture (corresponding to the first picture), or may be from an online document (corresponding to the second picture), which is not limited specifically herein.

With the display of the text and the picture in different lines, it can be ensured that the picture is in a proper position in the message card, avoiding neglect of the picture, picture offset, or the like, resulting from display of the text and the picture in the same line.

In some embodiments, the method further includes:

configuring a source description 622 which is configured to be displayed below the message card, where the source description includes an account name creating the message sending procedure.

By way of example, the source description may be “From: automated process of user name viewing online form.” Herein, the user name, and viewing online form can be varied with specific configuration of the automated messaging sending process.

Optionally, the source description may also be configured with a split line for differentiating the message text and the source description.

It is worth noting that attributes of the message card sent according to the method of the present disclosure conform to general standards of instant messaging applications.

Optionally, the width of the message card can be adjusted dynamically according to the width of the screen. Optionally, the message card does not support an internationalized card content. Optionally, the size of text information of the message card is not greater than 30 KB, including the image_key length of the picture while excluding the size of the picture itself; if it is greater than 30 KB, the run log displays the run failed.

Optionally, it is not allowed to point to all members in the message content, for example, @all.

In addition, a robotic examiner of the instant messaging application may examine the message card.

With the color palette, the capabilities of supporting the preset text markup syntax and supporting insertion of pictures, and the like, more diversified message contents can be provided and displayed in the form of a message card, thus enhancing the display effect.

In some embodiments, as shown in FIGS. 5A-6D, the message configuration interface further includes a preview function key; the method further includes:

in response to a trigger operation for the preview function key, sending, based on the edited message title and message content, a message card to a preview account of the instant messaging application according to a preset preview rule (as shown in FIG. 6E), wherein the preview account corresponds to an account creating the message sending procedure.

With the preview function, the variable content in the message card can be tested, and the settings of the message field can be examined, to instantly find problems. If the trigger condition is newly adding certain data, preview can be presented in the following way due to absence of data corresponding to the trigger condition, for example: the field variable is referenced, and the log of the multiline text is converted into the [field]; the log link is referenced for the button link, and the link is displayed as text[log link], making it impossible to jump; natural time is referenced for the content, and the current time for sending preview is sent.

Optionally, if preview failed, a prompt is given to allow the user to find the reason.

Step S705: in response to a confirm operation for saving and activation, saving and activating the message sending procedure.

In some embodiments, as shown in FIG. 5E, the sending object type is a group, and the sender is the first robot; the message configuration interface further includes a fourth prompt icon 521 for prompting that the first robot will be automatically added to the recipient group.

Further, the step of saving and activating the message sending procedure includes:

sending an add request to the instant messaging application, wherein the add request comprises adding the first robot to each corresponding group in the recipient group; wherein permissions of the first robot are determined based on group management settings corresponding to each group and an identity of an account creating the message sending procedure in a corresponding group.

By way of example, in an event that the group management setting is “Only group owner and group administrator can add group members,” if the account creating the automated message sending procedure is not the group owner or group administrator, the first robot cannot be added; at this time, the IM prompts a failure of “Only group owner and group administrator can add the robot,”and the online document run log displays a run failure and provides a failure reason.

In an event that the group management setting is “Only group owner and group administrator can message in the group,” if the account creating the automated message sending procedure is not the group owner or group administrator, after the automation is triggered, the IM displays that the first robot is invited to join the group but not allowed to push messages, and the online document run log displays that the run failed and provides a failure reason.

By way of example, if permission requirements are met, an IM group is created successfully, which has a prompt of “account name invites the first robot to join the group. New members can view all historical messages after joining the group”displayed therein.

Optionally, the message configuration interface includes an item of whether to activate a function. If the item of activing the function is selected, a Save and Activate Function button is displayed correspondingly; otherwise, a Save as Draft Function button is displayed.

Step S706: in response to a trigger condition of the message sending procedure being met, performing the message sending procedure. Performing the message sending procedure includes pushing, to the instant messaging application, a request for sending a message, and the like, which will not be detailed herein.

The embodiments of the present disclosure further provide a method of sending a message. As shown in FIG. 7, the method, which can be applied to an online document, specifically includes:

Step S702: in response to receiving, on an online document interface, a trigger operation for creating a message sending procedure, displaying a message configuration interface, wherein the message sending procedure is used for sending a message to an instant messaging application, and the message configuration interface comprises a message field comprising at least one of a message title, a message content and a message control;

Step S704: obtaining an editing operation for the message field, and matching a corresponding editing result based on the editing operation, and displaying the editing result on the message configuration interface; and

Step S705: in response to a confirm operation for saving and activation, saving and activating the message sending procedure.

In some embodiments, prior to Step S702, the method further includes:

Step S701: in response to a trigger operation for creating an automated process, displaying a process configuration interface, wherein the process configuration interface comprises a trigger condition interface and a to-be-selected process interface and wherein the to-be-selected process interface comprises a message sending procedure.

In some embodiments, after Step S705, the method further includes:

Step S706: in response to a trigger condition of the message sending procedure being met, performing the message sending procedure.

In some embodiments, the message configuration interface comprises at least one sending object type, and the method further includes:

Step S703: displaying, based on a selected sending object type, a corresponding message field on the message configuration interface. In some embodiments, displaying, based on the selected sending object type, the corresponding message field on the message configuration interface comprises:

in response to that the sending object type is an individual, the message field comprises a sender, a recipient, a message title, a message content and a message control; and/or

in response to that the sending object type is a group, the message field comprises a sender, a recipient group, a message title, a message content and a message control.

In some embodiments, an option of the sender comprises at least one of a first robot and a second robot;

wherein the first robot is preset in the instant messaging application and is capable of sending a message to each user of the instant messaging application; and

wherein the second robot is preset in a group of the instant messaging application and is capable of sending a message to the corresponding group.

In some embodiments, in response to that the sending object type is an individual, the option of the sender is configured as the first robot; and/or

in response to that the sending object type is a group, the option of the sender is configured as the first robot and the second robot.

In some embodiments, obtaining the editing operation for the message field, matching the corresponding editing result based on the editing operation, and displaying the editing result on the message configuration interface, comprise:

in response to determining the second robot as the sender, displaying, on the message configuration interface, a robot message address and at least one address bar, wherein the address bar is used for inputting a message address of the second robot.

In some embodiments, the message configuration interface further comprises an address adding item; and

in response to a trigger operation for the address adding option, adding the address bar.

In some embodiments, in response to an input operation of the second robot for a message address, the message address is verified according to a message address rule; and

in response to that the message address is not correct, an error is reported based on a preset text.

In some embodiments, in response to that the sending object type is an individual, the recipient is configured to support addition of an individual, an internal group and a combination of an individual and a group; or

in response to that the sending object type is a group, the recipient group is configured to support addition of an internal group and an external group.

In some embodiments, the recipient or the recipient group is configured with a search bar, and obtaining the editing operation for the message field, matching the corresponding editing result based on the editing operation, and displaying the editing result on the message configuration interface, comprise:

in response to an input operation for a search content, sending a request for searching for individuals and groups in contacts to the instant messaging application;

obtaining and displaying a search result fed back by the instant messaging application; and

in response to a selection operation for an individual or a group in the search result, adding a corresponding individual as the recipient, or adding a corresponding group as the recipient or the recipient group.

In some embodiments, in response to that the sending object type is a group, and the recipient is the first robot,

saving and activating the message sending procedure comprises:

sending an add request to the instant messaging application, wherein the add request comprises adding the first robot to each corresponding group in the recipient group;

wherein permissions of the first robot are determined based on group management settings corresponding to each group and an identity of an account creating the message sending procedure in a corresponding group.

In some embodiments, the message title is configured with a color palette, and obtaining the editing operation for the message field, matching the corresponding editing result based on the editing operation, and displaying the editing result on the message configuration interface, comprise:

in response to a trigger operation for the color palate, displaying at least two colors; and

in response to a selection operation for any of the at least two colors, determining a background color of the message title, and a font color matching the background color.

In some embodiments, the method further includes:

in response to editing the background color of the message title, configuring the message title to be displayed in the selected background color and matching font color in a message card of the instant messaging application.

In some embodiments, the message content is configured to support a preset text markup syntax, and wherein the preset text markup syntax is used for adjusting a format of a text.

In some embodiments, the method further includes:

in response to editing the message content using the preset text markup syntax, configuring the message content to be displayed in an effect corresponding to the preset text markup syntax in a message box of the instant messaging application.

In some embodiments, the message title is configured with a first reference mark or a second reference mark, and obtaining the editing operation for the message field, matching the corresponding editing result based on the editing operation, and displaying the editing result on the message configuration interface, comprise:

in response to a trigger operation for the first reference mark or the second reference mark, displaying at least one item to be selected; and

in response to a selection operation for the item to be selected, matching and displaying a corresponding effect interface based on the selected item to be selected, wherein the effect interface comprises displaying, in the message content, the selected item or a subsequent option available to a user.

In some embodiments, the item to be selected comprises a first picture, the subsequent option is used for specifying a target picture corresponding to the first picture, and the method further includes:

in response to a determining operation for the target picture, sending the target picture to the first robot to obtain a picture address of the target picture; and displaying the target picture in a preset format in the message content of the message configuration interface.

In some embodiments, the subsequent option comprises an information category of the online document, such that an information content corresponding to the information category is capable of being embedded into the message title or the message content.

In some embodiments, the method further includes:

in response to that the information category corresponds to a second picture, sending the target picture corresponding to the second picture to the first robot to obtain a picture address of the target picture, and presenting a field name corresponding to the target picture in the message content of the message configuration interface;

in response to that the information category corresponds to a person, converting the message content of the message configuration interface to point to the person; and

in response to that the information category corresponds to a text, displaying a category name corresponding to the text in the message content of the message configuration interface.

In some embodiment, the method further includes:

in response to a selection operation for the information category, configuring an information content corresponding to the information category to be displayed in a message box of the instant messaging application.

In some embodiments, the message control comprises an option on whether a button is to be added, and wherein the button is used for setting a link in the message;

and wherein the method further includes:

in response to a trigger operation for the option on whether a button to be added, displaying a button title input box on the message configuration interface and jumping to the button title input box.

In some embodiments, the message configuration interface further comprises a button adding item, and the method further includes:

in response to a trigger operation for the button adding item, adding a button title input box on the message configuration interface and jumping to an address input box.

In some embodiments, the method further includes:

in response to that a plurality of the buttons is provided, configuring the plurality of buttons to be displayed simultaneously in a message box of the instant messaging application.

In some embodiments, the message title, the message content and the message control are configured to form a message card in the instant messaging application.

In some embodiments, the method further includes: determining, based on a position order of the message title, the message content and the message control on the message configuration interface, a position order of the message title, the message content and the message control in the message box.

In some embodiments, the method further includes: in response to that the message content comprises a text and a picture, configuring, based on a position order of the text and the picture, a position order of the text and the picture in the message card, and displaying the text and the picture in different lines.

In some embodiments, the method further includes:

configuring a source description to be displayed below the message card, wherein the source description comprises a name of an account creating the message sending procedure.

In some embodiments, the message configuration interface further comprises a preview function key, and the method further includes:

in response to a trigger operation for the preview function key, sending, based on the edited message title and message content, a message card to a preview account of the instant messaging application according to a preset preview rule, wherein the preview account corresponds to an account creating the message sending procedure.

The method according to the embodiments of the present disclosure can be performed by a single device, for example, a computer or server, or the like. The method according to the embodiments of the present disclosure can be applied in a distributed scenario and implemented through cooperation of a plurality of devices. In the distributed scenario, one of the plurality of devices can perform only one or more steps of the method according to the embodiments of the present disclosure, and the plurality of devices can interact with one another to implement the method.

Some embodiments of the present disclosure have been described above. Other embodiments fall within the range defined by the appended claims. In some circumstances, the acts or steps as recited in the claims can be executed in an order different than the one described in the above embodiments, which can still achieve the desired result. Further, the process depicted in the drawings should not be understood as requiring the particular order shown or the sequential order to achieve the desired result. In some implementations, multitasking and parallel processing may be advantageous.

On the basis of the same invention concept, the present disclosure further provides an apparatus for sending a message corresponding to the method as described above according to any of the embodiments.

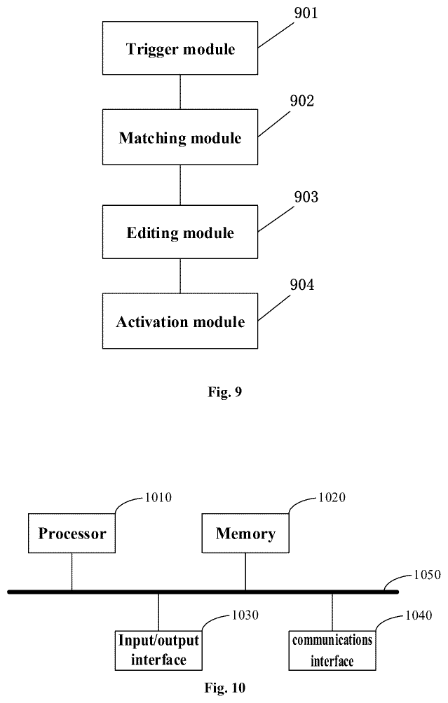

Referring to FIG. 9, the apparatus for sending a message includes:

a trigger module 901 configured to: in response to receiving, on an online document interface, a trigger operation for creating a message sending procedure, display a message configuration interface, wherein the message sending procedure is used for sensing a message to an instant messaging application, and the message configuration interface comprises a message field comprising at least one of a message title, a message content and a message control;

an editing module 903 configured to obtain an editing operation for the message field, and match a corresponding editing result based on the editing operation, and display the editing result on the message configuration interface; and

an activation module 904 configured to: in response to a confirm operation for saving and activation, save and activate the message sending procedure.

In some embodiments, the trigger module 901 is further configured to:

in response to a trigger operation for creating an automated process, display a process configuration interface, wherein the process configuration interface comprises a trigger condition interface and a to-be-selected process interface and wherein the to-be-selected process interface comprises a message sending procedure.

In some embodiments, the apparatus further includes a performing module configured to: in response to a trigger condition of the message sending procedure being met, perform the message sending procedure.

In some embodiments, the message configuration interface comprises at least one sending object type, and the apparatus further includes a matching module 902 configured to: display, based on a selected sending object type, a corresponding message field on the message configuration interface.

In some embodiments, the matching module 902 is configured such that:

in response to that the sending object type is an individual, the message field comprises a sender, a recipient, a message title, a message content and a message control; and/or

in response to that the sending object type is a group, the message field comprises a sender, a recipient group, a message title, a message content and a message control.

In some embodiments, an option of the sender comprises at least one of a first robot and a second robot;

wherein the first robot is preset in the instant messaging application and is capable of sending a message to each user of the instant messaging application; and

wherein the second robot is preset in a group of the instant messaging application and is capable of sending a message to the corresponding group.

In some embodiments, the matching module 902 is configured such that: in response to that the sending object type is an individual, the option of the sender is configured as the first robot; and/or

in response to that the sending object type is a group, the option of the sender is configured as the first robot and the second robot.

In some embodiments, the editing module 903 is configured to: in response to determining the second robot as the sender, display, on the message configuration interface, a robot message address and at least one address bar, wherein the address bar is used for inputting a message address of the second robot.

In some embodiments, the message configuration interface further comprises an address adding item; and in response to a trigger operation for the address adding option, the address bar is added.

In some embodiments, in response to an input operation of the second robot for a message address, the message address is verified according to a message address rule; and

in response to that the message address is not correct, an error is reported based on a preset text.

In some embodiments, in response to that the sending object type is an individual, the recipient is configured to support addition of an individual, an internal group and a combination of an individual and a group; and/or

in response to that the sending object type is a group, the recipient group is configured to support addition of an internal group and an external group.

In some embodiments, the recipient or the recipient group is configured with a search bar, and the editing module 903 is configured to: in response to an input operation for a search content, send a request for searching for individuals and groups in contacts to the instant messaging application;

obtain and display a search result fed back by the instant messaging application; and

in response to a selection operation for an individual or a group in the search result, add a corresponding individual as the recipient, or add a corresponding group as the recipient or the recipient group.

In some embodiments, in response to that the sending object type is a group, and the recipient is the first robot, the activation module 904 is configured to: send an add request to the instant messaging application, wherein the add request comprises adding the first robot to each corresponding group in the recipient group;

wherein permissions of the first robot are determined based on group management settings corresponding to each group and an identity of an account creating the message sending procedure in a corresponding group.

In some embodiments, the message title is configured with a color palette, and the editing module 903 is configured to:

in response to a trigger operation for the color palate, display at least two colors; and

in response to a selection operation for any of the at least two colors, determine a background color of the message title, and a font color matching the background color.

In some embodiments, the editing module 903 is configured to:

in response to editing the background color of the message title, configure the message title to be displayed in the selected background color and matching font color in a message card of the instant messaging application.

In some embodiments, the message content is configured to support a preset text markup syntax, and wherein the preset text markup syntax is used for adjusting a format of a text.

In some embodiments, the editing module 903 is configured to:

in response to editing the message content using the preset text markup syntax, configure the message content to be displayed in an effect corresponding to the preset text markup syntax in a message box of the instant messaging application.

In some embodiments, the message title is configured with a first reference mark or a second reference mark, and the editing module 903 is configured to: in response to a trigger operation for the first reference mark or the second reference mark, display at least one item to be selected; and

in response to a selection operation for the item to be selected, match and display a corresponding effect interface based on the selected item to be selected, wherein the effect interface comprises displaying, in the message content, the selected item or a subsequent option available to a user.

In some embodiments, the item to be selected comprises a first picture, the subsequent option is used for specifying a target picture corresponding to the first picture, and the editing module 903 is configured to: in response to a determining operation for the target picture, send the target picture to the first robot to obtain a picture address of the target picture; and display the target picture in a preset format in the message content of the message configuration interface.

In some embodiments, the subsequent option comprises an information category of the online document, such that an information content corresponding to the information category is capable of being embedded into the message title or the message content.

In some embodiments, the editing module 903 is configured to:

in response to that the information category corresponds to a second picture, send the target picture corresponding to the second picture to the first robot to obtain a picture address of the target picture, and present a field name corresponding to the target picture in the message content of the message configuration interface;

in response to that the information category corresponds to a person, convert the message content of the message configuration interface into the person; and in response to that the information category corresponds to a text, display a category name corresponding to the text in the message content of the message configuration interface.

In some embodiments, the editing module 903 is configured to: in response to a selection operation for the information category, configure an information content corresponding to the information category to be displayed in a message box of the instant messaging application.

In some embodiments, the message control comprises an option on whether a button is to be added, and wherein the button is used for setting a link in the message; and the apparatus is configured to: in response to a trigger operation for the option on whether a button to be added, display a button title input box on the message configuration interface and jumping to the button title input box.

In some embodiments, the message configuration interface further comprises a button adding item, and the apparatus is further configured to: in response to a trigger operation for the button adding item, add a button title input box on the message configuration interface and jumping to an address input box.

In some embodiments, the editing module 903 is configured to: in response to that a plurality of the buttons is provided, configure the plurality of buttons to be displayed simultaneously in a message box of the instant messaging application.

In some embodiments, the message title, the message content and the message control are configured to form a message card in the instant messaging application.

In some embodiments, the editing module 903 is configured to: determine, based on a position order of the message title, the message content and the message control on the message configuration interface, a position order of the message title, the message content and the message control in the message box.

In some embodiments, the editing module 903 is configured to: in response to that the message content comprises a text and a picture, configure, based on a position order of the text and the picture, a position order of the text and the picture in the message card, and displaying the text and the picture in different lines.

In some embodiments, the apparatus is configured to: configure a source description to be displayed below the message card, wherein the source description comprises a name of an account creating the message sending procedure.

In some embodiments, the message configuration interface further comprises a preview function key, and the apparatus is further configured to:

in response to a trigger operation for the preview function key, send, based on the edited message title and message content, a message card to a preview account of the instant messaging application according to a preset preview rule, wherein the preview account corresponds to an account creating the message sending procedure.

For convenience of describing the above apparatus, the description on respective modules thereof divided according to functions has been provided above. Of course, when the present disclosure is implemented, the functions of the respective modules can be implemented in one or more software units and/or hardware units.

The apparatus according to the above embodiments can be used to implement the corresponding method for sending a message described according to any of the above embodiments, and can achieve the advantageous effects of the corresponding method embodiments, which are omitted herein for brevity.

On the basis of the same invention concept, the present disclosure further provides an electronic device corresponding to the method described in any of the above embodiments, which includes a memory, a processor, and computer programs stored on the memory and operable on the processor, where the processor, when executing the programs, can implement the method for sending a message as described in any of the above embodiments.

FIG. 10 illustrates a schematic diagram of a hardware structure of an electronic device provided by embodiments of the present disclosure. The apparatus includes: a processor 1010, a memory 1020, an input/output interface 1030, a communications interface 1040 and a bus 1050. The processor 1010, the memory 1020, the input/output interface 1030 and the communications interface 1040 are communicatively connected to one another within the device via the bus 1050.

The processor 1010 can be implemented by using a general Central Processing Unit (CPU), a microprocessor, an Application-Specific Integrated Circuit (ASIC), one or more integrated circuits, etc., and is configured to execute a related program, so as to implement the technical solutions provided by the embodiments of the present disclosure.

The memory 1020 can be implemented by using a Read-Only Memory (ROM), a Random Access Memory (RAM), a static storage device, a dynamic storage device, and the like. The memory 1020 can store an operating system and other applications. When the technical solutions provided by the embodiments of the present specification are implemented by using software or firmware, related program code is stored in the memory 1020, and is invoked and executed by the processor 1010.

The input/output interface 1030 is configured to be connected to an input/output module, to input or output information. The input/output module (not shown in the figure) can be used as a component and configured in the device, or can be externally connected to the device, to provide a corresponding function. The input module may include a keyboard, a mouse device, a touchscreen, a microphone, various sensors, and the like. The output module may include a monitor, a speaker, a vibrator, an indicator, and the like.

The communication interface 1040 is configured to be connected to a communications module (not shown in the figure), to implement communication interaction between the device and a further device. The communication module can perform communication in a wired way (for example, via USB or a network cable), or can perform communication in a wireless way (for example, via a mobile network, Wi-Fi, or Bluetooth).

The bus 1050 includes a path to transmit information between components (for example, the processor 1010, the memory 1020, the input/output interface 1030 and the communications interface 1040) of the device.

It is worth noting that, although only the processor 1010, the memory 1020, the input/output interface 1030, the communications interface 1040 and the bus 1050 of the device are shown, the device may further include other components needed for normal running in practice. In addition, those skilled in the art could understand that the device can include only components necessary for implementing the solutions according to the embodiments of the present disclosure, but does not necessarily include all components shown in the figure.

The electronic device according to the above embodiments is used for implementing the corresponding method for sending a message according to any of the above embodiments, and can achieve the advantageous effects of the corresponding method embodiments, which are omitted herein for brevity.

On the basis of the same invention concept, the present disclosure further provides a non-transitory computer readable storage medium corresponding to the method according to any of the above methods, which stores thereon computer instructions that are used to cause a computer to perform the method for sending a message according to any of the embodiments described above.

The computer readable medium according to these embodiments may include permanent or non-permanent, movable or non-movable medium and can implement information storage by means of any method or technology. The information may be a computer readable instruction, a data structure, a program device or other data. The examples of a computer storage medium include, but are not limited to, a Phase-change Random Access Memory (PRAM), a Static Random Access Memory (SRAM), a Dynamic Random Access Memory (DRAM) or other type of Random Access Memory (RAM), a Read-Only Memory (ROM), an Electrically Erasable Programmable Read-Only Memory (EEPROM), a flash memory or other memory technology, a Compact Disk Read-Only Memory (CD-ROM), a Digital Versatile Disc (DVD) or other optical storage, a magnetic cassette tape, a magnetic tape and magnetic disk storage or other magnetic storage device, or any other non-transmission media, which can be used to store information that can be accessed by a computing device.

The computer instructions stored in the storage medium according to the above embodiments are used to cause the computer to implement the method for sending a message according to any of the embodiments described above, and can achieve the advantageous effects of the corresponding method embodiments, which are omitted herein for brevity.

It should be understood by those skilled in the art that the discussion of any of the above embodiments is merely exemplary, and is not intended to limit the scope of the present disclosure. According to the idea of the present disclosure, the technical features in the above embodiments or different embodiments may be combined, the steps may be carried out in any order, and many other variations may be made to the different aspects of the present disclosure as described above, which are not provided in detail for the sake of brevity.

In addition, for simplicity of illustration and discussion and in order not to obscure the present disclosure, well-known power/ground connections to integrated circuit (IC) chips and other components are not shown in the accompanying drawings. Furthermore, in order to avoid obscuring the present disclosure, devices may be shown in block diagrams, which are also based on the fact that the details of the embodiments of the devices shown in the block diagrams are highly dependent on a platform on which the present disclosure is to be implemented (i.e., these details should be fully understood by those skilled in the art). In such a case that specific details (e.g. circuits) are described to describe the exemplary embodiments of the present disclosure, it will be apparent to those skilled in the art that the present disclosure may be practiced without these specific details or with the specific details being changed. Accordingly, the description should be considered as illustrative rather than restrictive.

Although the present disclosure has been described in conjunction with the specific embodiments, many alternatives, modifications and variations of these embodiments will be apparent to those skilled in the art. For example, other memory architectures (e.g. dynamic RAM (DRAM)) may be used in the embodiments discussed above.

The embodiments of the present disclosure are intended to cover all alternatives, modifications and variations that fall within the broad scope of the appended claims. Therefore, any omissions, modifications, equivalents, and improvements, which are made within the spirit and principles of the present disclosure, are intended to be included within the scope of the present disclosure.

1. A message sending method, comprising:
in response to receiving, on an online document interface, a trigger operation for creating a message sending procedure, displaying a message configuration interface, wherein the message sending procedure is used for sending a message to an instant messaging application, and the message configuration interface comprises a message field comprising at least one of a message title, a message content and a message control;
obtaining an editing operation for the message field, matching a corresponding editing result based on the editing operation, and displaying the editing result on the message configuration interface; and
in response to a confirm operation for saving and activating, saving the editing result and activating the message sending procedure.

2. The method of claim 1, wherein prior to in response to receiving, on the online document interface, the trigger operation for creating the message sending procedure, displaying the message configuration interface, the method further comprises:
in response to a trigger operation for creating an automated process, displaying a process configuration interface, wherein the process configuration interface comprises a trigger condition interface and a process interface to be selected, and wherein the process interface to be selected comprises a message sending procedure,
and wherein after saving the editing result and activating the message sending procedure, the method further comprises:
in response to a trigger condition of the message sending procedure being met, performing the message sending procedure.

3. (canceled)

4. The method of claim 1, wherein the message configuration interface comprises at least one sending object type, and the method further comprises:
displaying, based on a selected sending object type, a corresponding message field on the message configuration interface,
and wherein displaying, based on the selected sending object type, the corresponding message field on the message configuration interface comprises:
in response to that the sending object type is an individual, the message field comprises a sender, a recipient, a message title, a message content and a message control; or
in response to that the sending object type is a group, the message field comprises a sender, a recipient group, a message title, a message content and a message control.

5. (canceled)

6. The message of claim 4, wherein an option of the sender comprises at least one of a first robot and a second robot;
wherein the first robot is preset in the instant messaging application and is capable of sending a message to each user of the instant messaging application; and
wherein the second robot is preset in a group of the instant messaging application and is capable of sending a message to the corresponding group.

7. The method of claim 6, wherein, in response to that the sending object type is an individual, the option of the sender is configured as the first robot; or
in response to that the sending object type is a group, the option of the sender is configured as the first robot and the second robot,
and wherein obtaining the editing operation for the message field, matching the corresponding editing result based on the editing operation, and displaying the editing result on the message configuration interface, comprise:
in response to determining the second robot as the sender, displaying, on the message configuration interface, a robot message address and at least one address bar, wherein the address bar is used for inputting a message address of the second robot.

8. (canceled)

9. The method of claim 4, wherein the message configuration interface further comprises an address adding item; and the method further comprises:
in response to a trigger operation for the address adding option, adding the address bar, and the method further comprises:
in response to an input operation of the second robot for a message address, verifying the message address according to a message address rule; and
in response to that the message address is not correct, reporting an error based on a preset text.

10. (canceled)

11. The method of claim 4, wherein, in response to that the sending object type is an individual, the recipient is configured to support addition of an individual, an internal group and a combination of an individual and a group; or
in response to that the sending object type is a group, the recipient group is configured to support addition of an internal group and an external group,
and wherein the recipient or the recipient group is configured with a search bar, and obtaining the editing operation for the message field, matching the corresponding editing result based on the editing operation, and displaying the editing result on the message configuration interface, comprise:
in response to an input operation for a search content, sending, to the instant messaging application, a request for searching for individuals and groups in contacts;
obtaining and displaying a search result fed back by the instant messaging application; and
in response to a selection operation for an individual or a group in the search result, adding a corresponding individual as the recipient, or adding a corresponding group as the recipient or the recipient group.

12. (canceled)

13. The method of claim 6, wherein, in response to that the sending object type is a group, and the recipient is the first robot, saving the editing result and activating the message sending procedure comprises:
sending an add request to the instant messaging application, wherein the add request comprises adding the first robot to each corresponding group in the recipient groups;
wherein permissions of the first robot are determined based on group management settings corresponding to each group and an identity of an account creating the message sending procedure in a corresponding group.

14. The method of claim 1, wherein the message title is configured with a color palette, and obtaining the editing operation for the message field, matching the corresponding editing result based on the editing operation, and displaying the editing result on the message configuration interface, comprise:
in response to a trigger operation for the color palate, displaying at least two colors; and
in response to a selection operation for any of the at least two colors, determining a background color of the message title, and a font color matching the background color, and wherein the method further comprises:
in response to editing the background color of the message title, configuring the message title to be displayed in the selected background color and matching font color in a message card of the instant messaging application.

15. (canceled)

16. The method of claim 1, wherein the message content is configured to support a preset text markup syntax, and wherein the preset text markup syntax is used for adjusting a format of a text,
and the method further comprises:
in response to editing the message content using the preset text markup syntax, configuring the message content to be displayed in an effect corresponding to the preset text markup syntax in a message box of the instant messaging application.

17. (canceled)

18. The method of claim 1, wherein the message title is configured with a first reference mark or a second reference mark, and obtaining the editing operation for the message field, matching the corresponding editing result based on the editing operation, and displaying the editing result on the message configuration interface, comprise:
in response to a trigger operation for the first reference mark or the second reference mark, displaying at least one item to be selected; and
in response to a selection operation for the item to be selected, matching and displaying a corresponding effect interface based on the selected item to be selected, wherein the effect interface comprises displaying, in the message content, the selected item or a subsequent option available to a user.

19. The method of claim 18, wherein the item to be selected comprises a first picture, the subsequent option is used for specifying a target picture corresponding to the first picture, and the method further comprises:
in response to a determining operation for the target picture, sending the target picture to the first robot to obtain a picture address of the target picture; and displaying the target picture in a preset format in the message content of the message configuration interface,
and wherein the subsequent option comprises an information category of the online document, such that an information content corresponding to the information category is capable of being embedded into the message title or the message content.

20. (canceled)

21. The method of claim 19, further comprising:
in response to that the information category corresponds to a second picture, sending the target picture corresponding to the second picture to the first robot to obtain a picture address of the target picture, and presenting a field name corresponding to the target picture in the message content of the message configuration interface;
in response to that the information category corresponds to a person, converting the message content of the message configuration interface to point to the person; and
in response to that the information category corresponds to a text, displaying a category name corresponding to the text in the message content of the message configuration interface,
and the method further comprises:
in response to a selection operation for the information category, configuring an information content corresponding to the information category to be displayed in a message box of the instant messaging application.

22. (canceled)

23. The method of claim 1, wherein the message control comprises an option on whether a button is to be added, and wherein the button is used for setting a link in the message;
and wherein the method further comprises:
in response to a trigger operation for the option on whether a button to be added, displaying a button title input box on the message configuration interface and jumping to the button title input box,
and wherein the message configuration interface further comprises a button adding item, and the method further comprises:
in response to a trigger operation for the button adding item, adding a button title input box on the message configuration interface and jumping to an address input box.

24. (canceled)

25. The method of claim 23, further comprising:
in response to that a plurality of the buttons is provided, configuring the plurality of buttons to be displayed simultaneously in a message box of the instant messaging application.

26. The method of claim 1, wherein the message title, the message content and the message control are configured to form a message card in the instant messaging application,
and wherein the method further comprises:
determining, based on a position order of the message title, the message content and the message control on the message configuration interface, a position order of the message title, the message content and the message control in the message box;
configuring a source description to be displayed below the message card, wherein the source description comprises a name of an account creating the message sending procedure.

27. (canceled)

28. The method of claim 26, further comprising:
in response to that the message content comprises a text and a picture, configuring, based on a position order of the text and the picture, a position order of the text and the picture in the message card, and displaying the text and the picture in different lines.

29. (canceled)

30. The method of claim 1, wherein the message configuration interface further comprises a preview function key, and the method further comprises:
in response to a trigger operation for the preview function key, sending, based on the edited message title and message content, a message card to a preview account of the instant messaging application according to a preset preview rule, wherein the preview account corresponds to an account creating the message sending procedure.

31. (canceled)

32. An electronic device comprising:
a memory;
a processor; and
a computer program executed on the processor, wherein the computer program, when executed by the processor, causes the processor
in response to receiving, on an online document interface, a trigger operation for creating a message sending procedure, display a message configuration interface, wherein the message sending procedure is used for sending a message to an instant messaging application, and the message configuration interface comprises a message field comprising at least one of a message title, a message content and a message control;
obtain an editing operation for the message field, match a corresponding editing result based on the editing operation, and display the editing result on the message configuration interface; and
in response to a confirm operation for saving and activating, save the editing result and activate the message sending procedure.

33. A non-transitory computer readable storage medium having computer instructions stored thereon, wherein the computer instructions, when executed by a computer, cause the computer to:
in response to receiving, on an online document interface, a trigger operation for creating a message sending procedure, display a message configuration interface, wherein the message sending procedure is used for sending a message to an instant messaging application, and the message configuration interface comprises a message field comprising at least one of a message title, a message content and a message control;
obtain an editing operation for the message field, match a corresponding editing result based on the editing operation, and display the editing result on the message configuration interface; and
in response to a confirm operation for saving and activating, save the editing result and activate the message sending procedure.
